(19) United States
(12) Patent Application Publication
(10) Pub. No.: US 2009/0196951 A1
(43) Pub. Date: Aug. 6, 2009

(54) Product and Method for Alcoholic Beverage Infused with Resveratrol

(76) Inventor: Ross Brandborg, Fargo, ND (US)

Correspondence Address: Ross Brandborg, 503 N. 7th St. #206, Fargo, ND, 58102, US

(21) Appl. No.: 12/421,235

(22) Filed: Apr. 9, 2009

Related U.S. Application Data
(60) Provisional application No. 61/160,669, filed on Mar. 16, 2009.

(51) Int. Cl. A23K 1/18; C12C 1/00; C12G 1/00

(52) U.S. Cl. 426/2; 426/592; 426/519

(57) ABSTRACT

This invention relates to the combination of an alcoholic beverage, such as vodka, gin, rum, tequila, whisky, beer, or wine with Resveratrol, an antioxidant and Sirtuin 1 (SIRT1) and PGC-1′ gene activating substance and additives such as sweeteners, masking agents, natural and/or artificial flavoring agents, and/or other additives to eliminate or mitigate any flavoring associated with Resveratrol.

### RELATED APPLICATIONS

This non-provisional application claims the benefit under Title 35, U.S.C. § 119(e) of co-pending U.S. provisional application No. 61/160,669, filed Mar. 16, 2009, which is incorporated herein by reference.

### FEDERALLY SPONSORED RESEARCH

N/A

### SEQUENCE LISTING OR PROGRAM

N/A

### BACKGROUND OF INVENTION

Products and method for the preparation and consumption of an alcohol-containing beverage which is combined with resveratrol. The present invention provides an alcoholic beverage and resveratrol composition. The present invention provides two methods, one for the delivery of resveratrol to the human body by dissolving the resveratrol in an alcoholic beverage and a methods for combing resveratrol in an alcoholic beverage.

Resveratrol is a substance that occurs naturally in different plants as a defense against infectious pathogens. Resveratrol is a strong anti-oxidant. Anti-oxidants have been shown to have many health benefits, including cancer fighting and improved cardiovascular health. In addition, Resveratrol stimulates the Sirtuin 1 (SIRT1) and PGC-1′ gene which causes the human body to maintain health and fight sickness and disease. Resveratrol is also considered to slow aging.

Resveratrol is currently available for human consumption in powder, pill, and liquid form. These products are dietary supplements similar to vitamin or mineral supplements.

Nutrient infused beverages are also available for human consumption. These beverages include sport energy drinks, malt/fermented beverages, carbonated beverages, and water containing caffeine or other nutrients.

Resveratrol is naturally present in wine because resveratrol is naturally present in the skin of grapes. The natural resveratrol in wine is in small amounts, higher doses provide the desired health benefits.

Alcoholic beverages are a good delivery vehicle for resveratrol because resveratrol is highly soluble in ethyl alcohol (ethanol). By contrast, resveratrol is nearly insoluble in water. This makes an alcoholic beverage a very good delivery vehicle for resveratrol. Mixing resveratrol with alcoholic beverages will facilitate consumption of the amounts of resveratrol necessary to achieve the desired health benefits.

The following prior art exists in the field of this invention:

U.S. patent application Ser. No. 11/407,666 by Michael C. Hearn, describes an alcoholic beverage containing caffeine.

U.S. Patent Application 2003/0134007 by Erik Thurman Donhowe describes an alcohol containing sport drink that alleges enhanced nutrition in comparison to existing alcoholic drinks.

U.S. Pat. No. 6,936,283 by Bjorn T. Langeland refers to a composition preferably manufactured as a beverage capable of promoting alcohol and acetalde-hyde metabolism to mitigate the burden on human body, thus effective for preventing over-drunkenness, drunken sickness, and hangover.

U.S. Patent Application 2004/0180112 by Yoshihide Hagiwara refers to a process for the production of alcoholic drinks having a rich aroma of coffee by utilizing an extraction residue of roasted coffee beans which is yielded in large amounts in the making of instant coffee, coffee drinks and the like.

U.S. Pat. No. 4,497,842 by Joseph R. Ehrlich et. al. refers to a method of preparing roasted citrus fruit peel which comprises extracting the roasted peel with aqueous ethanol, removing the aqueous ethanol from the peel and roasting the thus treated peel. The aqueous ethanol may be recovered for use as an alcoholic beverage. The treated peels useful in preparing a substitute for coffee or tea by extracting the treated peel with water.

### SUMMARY OF THE INVENTION

This invention relates to a composition of a beverage. The beverage is comprised of an alcoholic beverage, resveratrol, and flavoring agents. “Alcoholic beverages” is defined as any beverage containing at least 2% ethyl alcohol (ethanol) by volume (ABV), produced by any means. Alcoholic beverages are divided into three classes: malt beverages, spirits, and wines. This invention contemplates adding resveratrol and flavoring additives to alcoholic beverages in each of these classes. Resveratrol combined with alcoholic beverages will allow individuals to receive the positive benefits of resveratrol, an anti-oxidant, anti-aging compound, and Sirtuin 1 (SIRT1) and PGC-1′ gene stimulator, combined with the effects of an alcoholic beverage.

Another embodiment of the present invention describes a method comprising combining an alcoholic beverage with resveratrol and one or more flavoring additives.

Yet another embodiment of the present invention describes a method of delivering resveratrol to the human body by combing it with an alcoholic beverage and consuming the beverage.

### DETAILED DESCRIPTION

### Composition

This invention relates to a composition comprising a beverage. The beverage is comprised of an alcoholic beverage, resveratrol, and flavoring agents. “Alcoholic beverages” is defined as any beverage containing at least 2% ethyl alcohol (ethanol) by volume (ABV), produced by any means. Alcoholic beverages are divided into three classes: malt beverages, spirits, and wines. An examples of a malt beverage is beer, or any beverage made with a malting process. An example of a spirit is vodka or any distilled alcoholic beverage commonly referred to as hard alcohol. This invention contemplates adding resveratrol and flavoring additives to alcoholic beverages in each of these classes.

As used herein “resveratrol” is defined as the compound resveratrol as it exists as a pure chemical, also know as Trans-Resveratrol (5-[(E)-2-(4-hydroxphenyl)-ethenyl]benzene-1,3-diol) or an alternate form Cis-Resveratrol, or any other chemical form of resveratrol. The following illustration is the chemical structure of trans-resveratrol.

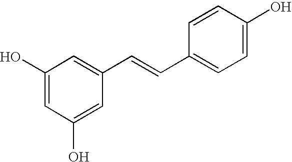

Other names:
trans-3,5,4′-trihydrozystilbene;
3,4′,5-stilbenetriol;
(E)-5-(p-hydroxystyryl)resorcinol
   Molecular formula: C₁₄H₁₂O₃

The only alcoholic beverage naturally containing a measurable amount of resveratrol is wine. The resveratrol found in wine is of an amount too small to provide the health benefits associated with higher doses of resveratrol. Adding resveratrol to alcoholic beverages allows the user to receive the desired health benefits associated with resveratrol.

In one embodiment the composition comprises a spirit to which resveratrol is added. Resveratrol is added so that the composition has at least 1 mg resveratrol per liter of spirit.

An alternative embodiment comprises a malt beverage to which resveratrol is added. Resveratrol is added so that the composition has at least 1 mg resveratrol per liter of malt beverage.

An alternative embodiment comprises wine to which resveratrol is added. Resveratrol is added so that the composition has at least 16 mg resveratrol per liter of wine.

An alternative embodiment comprising wine containing naturally occurring resveratrol to which resveratrol is added. Resveratrol is added so that the composition has at least 16 mg resveratrol per liter of wine.

In one embodiment the composition comprises a mixture of two or more spirits to which resveratrol is added. Resveratrol is added so that the composition has at least 1 mg resveratrol per liter of spirit.

An alternative embodiment comprising a spirit, wine, or malt beverage and resveratrol as described herein and additionally comprising least one flavorant or additive. Examples of suitable flavorant or additives are: sweeteners, masking agents, vanilla, anise, almond, pear extracts, cucumber extracts, apple flavorings, citrus extracts, glucose, corn syrup, sucrose, compositions and/or extracts thereof, or, ginseng, panax ginseng, taurine, D-ribose, I-carnitine, glucose, guarana, inositol, glucuronolactone, maltodextrine, niacinamide, niacin, calcium-pantothenate, pantothenic acid, vitamin B.sub.6, vitamin B.sub.12, vitamin C (ascorbic acid), folic acid, riboflaven, monopotassium phosphate, gum arabic, pyridoxine hydrochloride, sodium citrate, sorbic acid, benzoic acid, sucralose, cyanocobalamin, or caffeine.

### Method:

The method described in this invention in one embodiment comprises the combining through agitating or mixing means an alcoholic beverage with amounts of resveratrol described herein.

The method described in this invention in one embodiment comprises the combining through agitating or mixing means an alcoholic beverage with amounts of resveratrol described herein and at least one flavoring additive.

An alternative embodiment; upon combining resveratrol and any additives with an alcoholic beverage, the composition can be heated to 60-90 degree. C. for up to 2 minutes, followed by cooling to 20-35.degree. C or the composition can be combined and then cooled to 0 degree C.

An alternative embodiment; the method combines all ingredients into one container then agitated or mixed so the resveratrol is dissolved.

An alternative embodiment; a method where an increase in resveratrol content may allow for a directly proportional increase of some or all other additives. Mixing, heating and cooling can be adjusted accordingly. Any of the above formulations may be infused with fruit or other flavorings to make a flavored alcoholic beverage.

In an alternative embodiment the resveratrol is added to the manufacturing process of the alcoholic beverage.

In an alternative embodiment the resveratrol is added after the fermentation manufacturing step allowing the resveratrol to dissolve in the raw alcoholic beverage during the manufacturing process.

In an alternative embodiment the resveratrol is added to the manufacturing process of the alcoholic beverage prior to the fermentation step.

In an alternative embodiment the resveratrol is added to the manufacturing process after the alcoholic beverage manufacture is complete and allowed to dissolve either naturally or though the methods described herein.

The function and advantage of these and other embodiments of the present invention may be more fully understood from the examples below. The following examples, while illustrative of certain embodiments of the invention, do not exemplify the full scope of the invention.

### Example 1

Composition:
One liter 80 proof ethyl alcohol or clear neutral spirit
15 g powdered resveratrol
Combine all ingredients in one container. Composition may be heated up to 75° C. for up to 2 minutes Allow to cool for 5 minutes, or can be cooled to 0 degree C. before or during the mixing process.

### Example 2

One liter of 100% ethyl alcohol
50 g powdered resveratrol
Combine all ingredients in one container mix the contents of the container by agitating the container until all the resveratrol is dissolved in the alcohol.

### Example 3

Composition:
One liter 80 proof ethyl alcohol or clear neutral spirit
15 g powdered resveratrol
15 mL pure vanilla extract
0.03 mL pure almond extract
40 mg sucrose
Combine all ingredients in one container. Composition may be heated up to 75° C. for up to 2 minutes or cooled to 0 degrees C.

### Example 4

Composition:
One liter 80 Proof ethyl alcohol or clear neutral spirit
15 mg powdered resveratrol
60 mg sucrose
0.02 mL anise extract
10 mg sodium chloride
0.1 mL pure vanilla extract
Mix or agitate until all components are dissolved as a homogenous alcoholic beverage.

### Example 5

Composition:
One liter carbonated beer 3.5% ethyl alcohol
150 mg of powdered resveratrol
Slowly mix the powdered resveratrol in to beer, allow time for the resveratrol to dissolve in the beer, bottle and package.

### Example 6

Composition:
100 L 80 Proof ethyl alcohol or clear neutral spirit
1500 g resveratrol
1.5 mL of 0.25% sucralose solution
2 mL of 2% Firmenich Natural Masking Flavor 567164
Combine all ingredients into one container. Composition may be heated up to 75° C. for up to 2 minutes. Allow to cool for 5 minutes. By increasing factors of volume, immediately bottle and package.

### Example 7

Composition:
One liter red wine 9% ethyl alcohol
500 mg of powdered resveratrol
Slowly mix the powdered resveratrol in to wine, allow time for the resveratrol to dissolve in the wine, bottle and package.

While several embodiments of the invention have been described and illustrated herein, those of ordinary skill in the art upon the disclosure contained herein will readily envision a variety of other means and structures for performing the functions and/or obtaining the results or advantages described herein, and each of such variations, modifications and improvements is intended to be within the scope of the present invention. More generally, those skilled in the art upon this disclosure will readily appreciate that all parameters, quantities, materials, and compositions described herein are meant to be exemplary and that actual parameters, quantities, materials, and compositions will depend upon specific applications for which the teachings of the present invention are used.

Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, provided that such features, systems, materials and/or methods are not mutually inconsistent, is included within the scope of the present invention.

In the claims (as well as in the specification above), all transitional phrases or phrases of inclusion, such as “comprising,” “including,” “carrying,” “having,” “containing,” “composed of,” “made of,” “formed of,” “involving” and the like shall be interpreted to be open-ended, i.e. to mean “including but not limited to” and, therefore, encompassing the items listed thereafter and equivalents thereof as well as additional items. Only the transitional phrases or phrases of inclusion “consisting of” and “consisting essentially of” are to be interpreted as closed or semi-closed phrases, respectively. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. Only terms clearly indicated to the contrary, such as “only one of” or “exactly one of,” will refer to the inclusion of exactly one element of a number or list of element.

1. A composition comprising an alcoholic beverage to which resveratrol is added.

2. A composition as in claim 1, where the alcoholic beverage is a spirit and resveratrol is added so the composition contains at least 1 mg resveratrol per liter of spirit.

3. A composition as in claim 1, where the alcoholic beverage is a malt beverage and resveratrol is added so the composition contains at least 1 mg resveratrol per liter of malt beverage.

4. A composition as in claim 1, where the alcoholic beverage is wine and resveratrol is added so the composition contains at least 16 mg resveratrol per liter of wine.

5. A composition as claimed in claim 1, 2, 3, or 4 further comprising at least one flavoring or additive.

6. A method comprising:
a) combining spirits or malt beverages,
b) and at least 1 mg of resveratrol per liter of alcoholic beverage,
c) and optionally at least one flavorant or additive,
d) then all the ingredients are mixed by agitating means until all the components are dissolved in the alcoholic beverage.

7. A method comprising:
a) combining wine
b) and resveratrol in sufficient amounts to raise the amount of resveratrol to 16 mg per liter of alcoholic beverage and
c) optionally at least one flavorant or additive,
d) then all the ingredients are mixed by agitating means until all the components are dissolved in the alcoholic beverage.

8. A method comprising of; mixing resveratrol into the manufacturing process of an alcoholic beverage.

9. A method as in claim 8 further comprising; adding resveratrol after the fermentation step the manufacture process for the alcoholic beverage.

10. A method as in claim 8 further comprising; adding resveratrol prior to the fermentation step in the manufacturing process for the alcoholic beverage.

11. A method as in claim 8 further comprising; adding resveratrol after the completion of the manufacturing process of the alcoholic beverage.

12. A method as in claim 8 further comprising; adding resveratrol at various different stages of the manufacturing process of the alcoholic beverage.

13. A method of administering resveratrol to the human body comprising; consumption of alcoholic beverages which have been infused with resveratrol or additional resveratrol.

14. A method as in claim 13 further comprising; administering resveratrol to the human body by consumption of wine which has been infused to contain at least 16 mg of resveratrol per liter of selected wine alcoholic beverage.

15. A method as in claim 13 further comprising; administering resveratrol to the human body by consumption of spirit or malted beverage which has been infused to contain at least 1 mg of resveratrol per liter of spirit or malted beverage.
